(19) United States
(12) Patent Application Publication
(10) Pub. No.: US 2025/0368761 A1
(43) Pub. Date: Dec. 4, 2025

(54) UNIMODAL HIGH DENSITY POLYETHYLENE FOR CAP AND CLOSURE DEVICES

(71) Applicant: Dow Global Technologies LLC, Midland, MI (US)

(72) Inventors: Fengyi Zhang, Missouri City, TX (US); Xiaosong Wu, Sugar Land, TX (US); Rhett A. Baillie, Missouri City, TX (US)

(21) Appl. No.: 18/875,465

(22) PCT Filed: Aug. 4, 2023
(86) PCT No.: PCT/US2023/029527

§ 371 Date: Dec. 16, 2024

Related U.S. Application Data
(60) Provisional application No. 63/395,376, filed on Aug. 5, 2022.
(60) Provisional application No. 63/395,369, filed on Aug. 5, 2022.

(51) Int. Cl. C08F 10/02; B65D 41/04

(52) U.S. Cl. CPC C08F 10/02; B65D 41/04

(57) ABSTRACT

Embodiments of the present disclosure are directed towards unimodal high density polyethylene for cap and closure devices.

### FIELD OF DISCLOSURE

Embodiments of the present disclosure are directed towards polyethylene compositions for cap and closure. More specifically, the disclosure relates to high density polyethylene compositions for injection molded caps and closures that have high yield strength, high stiffness, and high creep resistance.

### BACKGROUND

Polymer resins play an important role in cap and closure (C&C) devices, providing functionalities such as sealing, protection, and convenience in various industries such as packaging, pharmaceuticals, beverages, and cosmetics. One challenging area for C&C devices is in cold sealing applications. Ideally, polymer resins used in C&C devices for cold sealing applications would have a balance between processibility, stiffness, toughness including environmental stress cracking resistance (ESCR), impact strength and creep resistance to obtain the required package integrity for cold sealing applications.

There are, however, tradeoffs between these factors. For example, achieving high toughness typically requires a balance between molecular weight, molecular weight distribution, comonomer amount(s) and comonomer distribution. Resins with higher molecular weight and narrower molecular weight distribution tend to offer better impact strength. However, these resins may have reduced processability due to their higher viscosity, which can lead to challenges during molding or processing. Resins with lower amounts of comonomer can have higher yield strength thus higher creep resistance, which is desirable in cold sealing applications to ensure the closure maintains its shape and structural integrity even under pressure. Resins with higher yield strength, high stiffness and creep resistance, may have reduced ESCR or processability. Therefore, there is a need in the art for a polymer resin that meets the desired high stiffness and high yield strength requirements while maintaining acceptable levels of processability and toughness.

### SUMMARY

The present disclosure provides various embodiments of a polymer resin that has high stiffness, and high yield strength requirements while maintaining acceptable levels of processability and toughness for use in a method that includes the following. A method of forming a closure device that includes supplying a high density polyethylene (HDPE) resin having: a density of 0.950 to 0.960 g/cm³; a melt index (I₂) of 1.000 to 5.000 dg/min measured according to ASTM D1238 (190° C., 2.16 kg); a Mn of 25000 to 45000; a Mw of 80000 to 125000; a Mz of 180000 to 350000; and a molecular weight distribution Mw/Mn of 2.5 to 3.5; a molecular weight comonomer distribution index (MWCDI)>0.2; and forming the closure device with the HDPE resin.

An examples of the closure device is a screw cap.

### BRIEF DESCRIPTION OF THE DRAWINGS

FIG. 1 show data plots of density and peak melting temperature relationships of Inventive Examples and Comparative Examples from the Examples Section, in accordance with a number of embodiments of the present disclosure.

### DETAILED DESCRIPTION

Injection molding is a process for producing cap and closure (C&C) devices by injecting molten material, e.g., polymer, into a mold. Molten material that is injected into the mold can be cooled so that the molten material hardens configured to the mold to make the article. Injection molding is a well-known process.

Injection molding can be utilized to make C&C devices, such as threaded bottle caps or screw caps, flip-top caps, dispensing caps, child-resistant caps, tamper-evident caps and snap-on caps, to name just a few. When such C&C devices are used in cold sealing applications, as discussed herein, it is desirable for the polymer used in forming the C&C devices to have both a high yield strength and flexibility or processability. The present disclosure provides for such a polymer that can be used in forming C&C devices.

The HDPE resin of the present disclosure is a HDPE resin that provides for a desirable balance between impact strength, yield strength, processibility and stiffness useful in specialized high-impact-rating closures, such as for low-temperature storage container. Prior to the HDPE resin of the present disclosure, resins often had to sacrifice processibility or stiffness to obtain the required impact strength and yield strength. The HDPE resin of the present disclosure helps to improve low temperature impact resistance and tensile performance without sacrificing processibility, ESCR, and stiffness.

In addition, the HDPE resin of the present disclosure is a unimodal resin in that the HDPE resin has a single mode or peak in its molecular weight distribution. As appreciated, this unimodal state allows for the HDPE resin of the present disclosure to exhibit more uniform properties (e.g., melt flow among others) and mechanical, thermal, and processing behaviors as compared to polymers with broader or bimodal molecular weight distributions.

The HDPE resin of the present disclosure can be formed using the catalyst compositions discussed herein, where the catalyst compositions include asymmetrical hafnium metallocenes having an n-propyl cyclopentadienyl ligand. This catalyst composition is a single site metallocene catalyst that is used to polymerize ethylene and an alpha olefin to produce the HPDE resin. These catalyst compositions can be utilized to make the HDPE resin with a number of desirable properties as discussed herein (e.g., impact resistance, low temperature flexibility, consistent melt flow behavior leading to improved processability). The HDPE resin of the present disclosure is used in a method of forming a closure device that includes supplying the HDPE resin, where the HDPE resin has among other things the following properties: a density of 0.950 to 0.960 g/cm³; a melt index (I₂) of 1.000 to 5.000 dg/min measured according to ASTM D1238 (190° C., 2.16 kg); a Mn of 25000 to 45000; a Mw of 80000 to 125000; a Mz of 180000 to 350000; and a molecular weight distribution Mw/Mn of 2.5 to 3.5. The HDPE resin of the present disclosure can further include a molecular weight comonomer distribution index>0.2; where the HDPE resin has a Charpy impact (−40° C.) of greater than 5 to 15 kJ/m² and an average tensile yield stress (2 in/min test speed) of 3.8 ksi to 4.2 ksi.

The asymmetrical hafnium metallocenes having an n-propyl cyclopentadienyl ligand can be represented by structure (I):

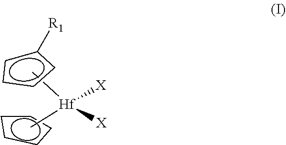

where: R¹ is n-propyl, and each X is independently a leaving group. As shown in structure (I), the upper cyclopentadienyl ring is substituted with the R¹ group, and the lower cyclopentadienyl ring is unsubstituted. As one cyclopentadienyl ring is substituted with the R¹ group and the other cyclopentadienyl ring is unsubstituted, the metallocenes can be referred to as asymmetrical hafnium metallocenes.

Embodiments of the present disclosure provide that X is a leaving group. One or more embodiments provide that X is selected from alkyls, aryls, hydridos, and halogens. One or more embodiments provide that X is selected from a halogen, (C₁-C₅)alkyl, CH₂SiMe₃, and benzyl. One or more embodiments provide that X is selected from alkyls and halogens. One or more embodiments provide that X is Cl. One or more embodiments provide that X is methyl.

Examples of X include halogen ions, hydrides, (C₁ to C₁₂)alkyls, (C₂ to C₁₂)alkenyls, (C₆ to C₁₂)aryls, (C₇ to C₂₀)alkylaryls, (C₁ to C₁₂)alkoxys, (C₆ to C₁₆)aryloxys, (C₇ to C₈)alkylaryloxys, (C₁ to C₁₂)fluoroalkyls, (C₆ to C₁₂)fluoroaryls, and (C₁ to C₁₂)heteroatom-containing hydrocarbons and substituted derivatives thereof; one or more embodiments include hydrides, halogen ions, (C₁ to C₆)alkyls, (C₂ to C₆) alkenyls, (C₇ to C₁₈)alkylaryls, (C₁ to C₆)alkoxys, (C₆ to C₁₄)aryloxys, (C₇ to C₁₆) alkylaryloxys, (C₁ to C₆)alkylcarboxylates, (C₁ to C₆)fluorinated alkylcarboxylates, (C₆ to C₁₂)arylcarboxylates, (C₇ to C₁₈)alkylarylcarboxylates, (C₁ to C₆)fluoroalkyls, (C₂ to C₆)fluoroalkenyls, and (C₇ to C₁₈)fluoroalkylaryls; one or more embodiments include hydride, chloride, fluoride, methyl, phenyl, phenoxy, benzoxy, tosyl, fluoromethyls and fluorophenyls; one or more embodiments include (C₁ to C₁₂)alkyls, (C₂ to C₁₂)alkenyls, (C₆ to C₁₂)aryls, (C₇ to C₂₀)alkylaryls, substituted (C₁ to C₁₂)alkyls, substituted (C₆ to C₁₂)aryls, substituted (C₇ to C₂₀)alkylaryls, and (C₁ to C₁₂)heteroatom-containing alkyls, (C₁ to C₁₂)heteroatom-containing aryls, and (C₁ to C₁₂)heteroatom-containing alkylaryls; one or more embodiments include chloride, fluoride, (C₁ to C₆)alkyls, (C₂ to C₆)alkenyls, (C₇ to C₁₈)alkylaryls, halogenated (C₁ to C₆)alkyls, halogenated (C₂ to C₆) alkenyls, and halogenated (C₇ to C₁₈)alkylaryls; one or more embodiments include fluoride, methyl, ethyl, propyl, phenyl, methylphenyl, dimethylphenyl, trimethylphenyl, fluoromethyls (mono-, di- and trifluoromethyls) and fluorophenyls (mono-, di-, tri-, tetra- and pentafluorophenyls).

Other non-limiting examples of X groups include amines, phosphines, ethers, carboxylates, dienes, hydrocarbon radicals having from 1 to 20 carbon atoms, fluorinated hydrocarbon radicals, e.g., —C₆F₅ (pentafluorophenyl), fluorinated alkylcarboxylates, e.g., CF₃C(O)O—, hydrides, halogen ions and combinations thereof. Other examples of X ligands include alkyl groups such as cyclobutyl, cyclohexyl, methyl, heptyl, tolyl, trifluoromethyl, tetramethylene, pentamethylene, methylidene, methyoxy, ethyoxy, propoxy, phenoxy, bis(N-methylanilide), dimethylamide, and dimethylphosphide radicals, among others. In one embodiment, two or more X's form a part of a fused ring or ring system. In one or more embodiments, X can be a leaving group selected from the group consisting of chloride ions, bromide ions, (C₁ to C₁₀)alkyls, (C₂ to C₁₂)alkenyls, carboxylates, acetylacetonates, and alkoxides. In one or more embodiments, X is methyl.

The asymmetrical hafnium metallocenes having an n-propyl cyclopentadienyl ligand discussed herein can be made by contacting a hafnium complex with an alkali metal complex to make the asymmetrical hafnium metallocenes having an n-propyl cyclopentadienyl ligand. The asymmetrical hafnium metallocenes having an n-propyl cyclopentadienyl ligand discussed herein can be made by processes, e.g., with conventional solvents, reaction conditions, reaction times, and isolation procedures, utilized for making known metallocenes.

The alkali metal complex can be represented by one of the following structures:

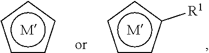

where M′ is lithium, sodium, or potassium and R¹ is n-propyl.

One or more embodiments provide that the hafnium complex can be represented by one the following structures:

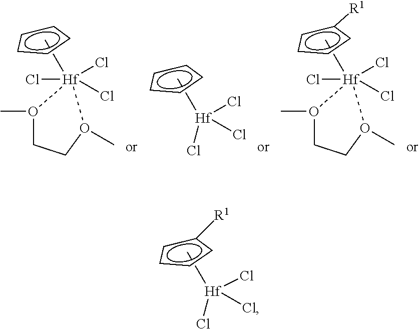

where R¹ is n-propyl.

One or more embodiments provide that making the asymmetrical hafnium metallocenes having an n-propyl cyclopentadienyl ligand, comprises contacting the asymmetrical hafnium metallocenes having an n-propyl cyclopentadienyl ligand with two mole equivalents of an organomagnesium halide of formula RMg(halide) or one mole equivalent of R₂Mg, where R is (C₁-C₅)alkyl, CH₂SiMe₃, or benzyl; and the halide is Cl or Br, to make the asymmetrical hafnium metallocenes having an n-propyl cyclopentadienyl ligand of structure (I) where each X is a halogen, a (C₁-C₅)alkyl, CH₂SiMe₃, or benzyl. One or more embodiments provide X is a (C₁-C₅)alkyl, CH₂SiMe₃, or benzyl. As used herein, all reference to the Periodic Table of the Elements and groups thereof is to the NEW NOTATION published in HAWLEY'S CONDENSED CHEMICAL DICTIONARY, Thirteenth Edition, John Wiley & Sons, Inc., (1997) (reproduced there with permission from IUPAC), unless reference is made to the Previous IUPAC form noted with Roman numerals (also appearing in the same), or unless otherwise noted.

As used herein, an “alkyl” includes linear, branched and cyclic paraffin radicals that are deficient by one hydrogen. Thus, for example, CH₃ (“methyl”) and CH₂CH₃ (“ethyl”) are examples of alkyls.

As used herein, an “alkenyl” includes linear, branched and cyclic olefin radicals that are deficient by one hydrogen; alkynyl radicals include linear, branched and cyclic acetylene radicals deficient by one hydrogen radical.

As used herein, “aryl” groups include phenyl, naphthyl, pyridyl and other radicals whose molecules have the ring structure characteristic of benzene, naphthylene, phenanthrene, anthracene, etc. It is understood that an “aryl” group can be a C₆ to C₂₀ aryl group. For example, a C₆H₅ aromatic structure is an “phenyl”, a C₆H₄ 2 aromatic structure is an “phenylene”. An “arylalkyl” group is an alkyl group having an aryl group pendant therefrom. It is understood that an “aralkyl” group can be a (C₇ to C₂₀ aralkyl group. An “alkylaryl” is an aryl group having one or more alkyl groups pendant therefrom.

As used herein, an “alkylene” includes linear, branched and cyclic hydrocarbon radicals deficient by two hydrogens. Thus, CH₂ (“methylene”) and CH₂CH₂ (“ethylene”) are examples of alkylene groups. Other groups deficient by two hydrogen radicals include “arylene” and “alkenylene”.

As used herein, the term “heteroatom” includes any atom selected from the group consisting of B, Al, Si, Ge, N, P, O, and S. A “heteroatom-containing group” is a hydrocarbon radical that contains a heteroatom and may contain one or more of the same or different heteroatoms, and from 1 to 3 heteroatoms in a particular embodiment. Non-limiting examples of heteroatom-containing groups include radicals (monoradicals and diradicals) of imines, amines, oxides, phosphines, ethers, ketones, oxoazolines heterocyclics, oxazolines, and thioethers.

As used herein, the term “substituted” means that one or more hydrogen atoms in a parent structure has been independently replaced by a substituent atom or group.

The asymmetrical hafnium metallocenes having an n-propyl cyclopentadienyl ligand discussed herein can be utilized to make catalyst compositions, e.g., injection molding compositions. These compositions include the asymmetrical hafnium metallocenes discussed herein and an activator. The asymmetrical hafnium metallocenes discussed herein and the activator can be contacted to make a catalyst composition. One or more embodiments provide that the activator is an alkylaluminoxane such as methylaluminoxane. As used herein, “activator” refers to any compound or combination of compounds, supported, or unsupported, which can activate a complex or a catalyst component, such as by creating a cationic species of the catalyst component. For example, this can include the abstraction of at least one leaving group, e.g., the “X” groups described herein, from the metal center of the complex/catalyst component, e.g., the asymmetrical hafnium metallocene having an n-propyl cyclopentadienyl ligand of Structure (I). The activator may also be referred to as a “co-catalyst”. As used herein, “leaving group” refers to one or more chemical moieties bound to a metal atom and that can be abstracted by an activator, thus producing a species active towards olefin polymerization. Various catalyst compositions, e.g., olefin polymerization catalyst compositions, are known in the art and different known catalyst composition components may be utilized. Various amounts of known catalyst composition components may be utilized for different applications.

The asymmetrical hafnium metallocenes having an n-propyl cyclopentadienyl ligand discussed herein can be utilized to make spray-dried compositions. As used herein, “spray-dried composition” refers to a composition that includes a number of components that have undergone a spray-drying process. Various spray-drying process are known in the art and are suitable for forming the spray-dried compositions disclosed herein. One or more embodiments provide that the spray-dried composition comprises a trim composition.

In one or more embodiments, the spray-drying process may comprise atomizing a composition including the asymmetrical hafnium metallocene having an n-propyl cyclopentadienyl ligand discussed herein. A number of other known components may be utilized in the spray-drying process. An atomizer, such as an atomizing nozzle or a centrifugal high speed disc, for example, may be used to create a spray or dispersion of droplets of the composition. The droplets of the composition may then be rapidly dried by contact with an inert drying gas. The inert drying gas may be any gas that is non-reactive under the conditions employed during atomization, such as nitrogen, for example. The inert drying gas may meet the composition at the atomizer, which produces a droplet stream on a continuous basis. Dried particles of the composition may be trapped out of the process in a separator, such as a cyclone, for example, which can separate solids formed from a gaseous mixture of the drying gas, solvent, and other volatile components.

A spray-dried composition may have the form of a free-flowing powder, for instance. After the spray-drying process, the spray-dried composition and a number of known components may be utilized to form a slurry. The spray-dried composition may be utilized with a diluent to form a slurry suitable for use in olefin polymerization, for example. In one or more embodiments, the slurry may be combined with one or more additional catalysts or other known components prior to delivery into a polymerization reactor.

In one or more embodiments, the spray-dried composition may be formed by contacting a spray dried activator particle, such as spray dried MAO, with a solution of the asymmetrical hafnium metallocene having an n-propyl cyclopentadienyl ligand discussed herein. Such a solution typically may be made in an inert hydrocarbon solvent, for instance, and is sometimes called a trim solution. Such a spray-dried composition comprised of contacting a trim solution of the asymmetrical hafnium metallocene having an n-propyl cyclopentadienyl ligand with a spray dried activator particle, such as spray-dried MAO, may be made in situ in a feed line heading into a gas phase polymerization reactor by contacting the trim solution with a slurry, typically in mineral oil, of the spray-dried activator particle.

Various spray-drying conditions may be utilized for different applications. For instance, the spray-drying process may utilize a drying temperature from 75 to 185° C. Other drying temperatures are possible, where the temperature can depend on the metallocene and activator particle. Various sizes of orifices of the atomizing nozzle employed during the spray-drying process may be utilized to obtain different particle sizes. Alternatively, for other types of atomizers such as discs, rotational speed, disc size, and number/size of holes may be adjusted to obtain different particle sizes. One or more embodiments provide that a filler may be utilized in the spray-drying process. Different fillers and amounts thereof may be utilized for various applications.

The asymmetrical hafnium metallocenes having an n-propyl cyclopentadienyl ligand discussed herein, e.g., injection molding compositions, such as the spray-dried hafnium metallocene composition, may be utilized to make a polymer. For instance, the asymmetrical hafnium metallocene having an n-propyl cyclopentadienyl ligand may be activated, i.e., with an activator, to make a catalyst. One or more embodiments provide that the spray-dried compositions include an activator. As used herein, “activator” refers to any compound or combination of compounds, supported, or unsupported, which can activate a complex or a catalyst component, such as by creating a cationic species of the catalyst component, e.g., to provide the catalyst. The activator may also be referred to as a “co-catalyst”. The activator can include a Lewis acid or a non-coordinating ionic activator or ionizing activator, or any other compound including Lewis bases, aluminum alkyls, and/or conventional-type co-catalysts. Activators include methylaluminoxane (MAO) and modified methylaluminoxane (MMAO), among others. One or more embodiments provide that the activator is methylaluminoxane. Activating conditions are well known in the art. Known activating conditions may be utilized.

A molar ratio of metal, e.g., aluminum, in the activator to hafnium in the asymmetrical hafnium metallocene having an n-propyl cyclopentadienyl ligand may be 1500:1 to 0.5:1, 300:1 to 1:1, or 150:1 to 1:1. One or more embodiments provide that the molar ratio of in the activator to hafnium in the asymmetrical hafnium metallocene having an n-propyl cyclopentadienyl ligand is at least 75:1. One or more embodiments provide that the molar ratio of in the activator to hafnium in the asymmetrical hafnium metallocene having an n-propyl cyclopentadienyl ligand is at least 100:1. One or more embodiments provide that the molar ratio of in the activator to hafnium in the asymmetrical hafnium metallocene having an n-propyl cyclopentadienyl ligand is at least 150:1.

The asymmetrical hafnium metallocenes having an n-propyl cyclopentadienyl ligand discussed herein, as well as a number of other components, can be supported on the same or separate supports, or one or more of the components may be used in an unsupported form. Utilizing the support may be accomplished by any technique used in the art. One or more embodiments provide that the spray-dry process is utilized. The support may be functionalized. One or more embodiments provide that the spray-dried compositions include a support.

A “support”, which may also be referred to as a “carrier”, refers to any support material, including a porous support material, such as talc, inorganic oxides, and inorganic chlorides. Other support materials include resinous support materials, e.g., polystyrene, functionalized or crosslinked organic supports, such as polystyrene divinyl benzene polyolefins or polymeric compounds, zeolites, clays, or any other organic or inorganic support material and the like, or mixtures thereof.

Support materials include inorganic oxides that include Group 2, 3, 4, 5, 13 or 14 metal oxides. Some preferred supports include silica, fumed silica, alumina, silica-alumina, and mixtures thereof. Some other supports include magnesia, titania, zirconia, magnesium chloride, montmorillonite, phyllosilicate, zeolites, talc, clays, and the like. Also, combinations of these support materials may be used, for example, silica-chromium, silica-alumina, silica-titania and the like. One or more embodiments provide that the support is silica, One or more embodiments provide that the support is hydrophobic fumed silica. One or more embodiments provide that the support is dehydrated silica. Additional support materials may include porous acrylic polymers, nanocomposites, aerogels, spherulites, and polymeric beads. An example of a support is fumed silica available under the trade name Cabosil™ TS-610, or other TS- or TG-series supports, available from Cabot Corporation. Fumed silica is typically a silica with particles 7 to 30 nanometers in size that has been treated with dimethylsilyldichloride such that a majority of the surface hydroxyl groups are capped.

The asymmetrical hafnium metallocenes having an n-propyl cyclopentadienyl ligand discussed herein, e.g., the injection molding compositions/catalyst compositions/spray-dried compositions, and an olefin can be contacted under polymerization conditions to make a polymer, e.g., the HDPE resin of the present disclosure. The polymerization process may be a suspension polymerization process, a slurry polymerization process, and/or a gas phase polymerization process. The polymerization process may utilize using known equipment and reaction conditions, e.g., known polymerization conditions. The polymerization process is not limited to any specific type of polymerization system. The polymer can be utilized for a number of articles, such as injection molded articles, e.g., a cap or a closure device such as a screw cap for a container.

One or more embodiments provide that the polymers are made utilizing a gas-phase reactor system. One or more embodiments provide that a single gas-phase reactor, e.g., in contrast to a series of reactors, is utilized. In other words, polymerization reaction occurs in only one reactor. For instance, the polymers can be made utilizing a fluidized bed reactor. Gas-phase reactors are known and known components may be utilized for the fluidized bed reactor.

As used herein an “olefin,” which may be referred to as an “alkene,” refers to a linear, branched, or cyclic compound including carbon and hydrogen and having at least one double bond. As used herein, when a polyolefin, polymer, and/or copolymer is referred to as comprising, e.g., being made from, an olefin, the olefin present in such polymer or copolymer is the polymerized form of the olefin. For example, when a copolymer is said to have an ethylene content of 75 wt % to 95 wt %, it is understood that the polymer unit in the copolymer is derived from ethylene in the polymerization reaction(s) and the derived units are present at 75 wt % to 95 wt %, based upon the total weight of the polymer. A higher α-olefin refers to an α-olefin having 3 or more carbon atoms.

Polyolefins made with the compositions discussed herein can made from olefin monomers such as ethylene, i.e., polyethylene, and linear or branched higher alpha-olefin monomers containing 3 to 20 carbon atoms. Examples of higher alpha-olefin monomers include, but are not limited to, propylene, butene, pentene, 1-hexene, and 1-octene. Examples of polyolefins include ethylene-based polymers, having at least 50 wt % ethylene, including ethylene-1-butene, ethylene-1-hexene, and ethylene-1-octene copolymers, among others. One or more embodiments provide that the polymer can include from 50 to 99.9 wt % of units derived from ethylene based on a total weight of the polymer. All individual values and subranges from 50 to 99.9 wt % are included; for example, the polymer can include from a lower limit of 50, 60, 70, 80, or 90 wt % of units derived from ethylene to an upper limit of 99.9, 99.7, 99.4, 99, 96, 93, 90, or 85 wt % of units derived from ethylene based on the total weight of the polymer. The polymer can include from 0.1 to 50 wt % of units derived from comonomer based on the total weight of the polymer. One or more embodiments provide that ethylene is utilized as a monomer and hexene is utilized as a comonomer.

As mentioned, the polymers made with the compositions disclosed herein can be made in a fluidized bed reactor. The fluidized bed reactor can have a reaction temperature from 10 to 130° C. All individual values and subranges from 10 to 130° C. are included; for example, the fluidized bed reactor can have a reaction temperature from a lower limit of 10, 20, 30, 40, 50, or 55° C. to an upper limit of 130, 120, 110, 100, 90, 80, 70, or 60° C.

The fluidized bed reactor can have an ethylene partial pressure from 30 to 250 pounds per square inch (psi). All individual values and subranges from 30 to 250 are included; for example, the fluidized bed reactor can have an ethylene partial pressure from a lower limit of 30, 45, 60, 75, 85, 90, or 95 psi to an upper limit of 250, 240, 220, 200, 150, or 125 psi.

One or more embodiments provide that ethylene is utilized as a monomer and hexene is utilized as a comonomer. The fluidized bed reactor can have a comonomer to ethylene mole ratio, e.g., C₆/C₂, from 0.0001 to 0.100. All individual values and subranges from 0.0001 to 0.100 are included; for example, the fluidized bed reactor can have a comonomer to ethylene mole ratio from a lower limit of 0.0001, 0.0005, 0.0007, 0.001, 0.0015, 0.002, 0.007, or 0.010 to an upper limit of 0.100, 0.080, or 0.050.

When hydrogen is utilized for a polymerization process, the fluidized bed reactor can have a hydrogen to ethylene mole ratio (H₂/C₂) from 0.00001 to 0.90000, for instance. All individual values and subranges from 0.00001 to 0.90000 are included; for example, the fluidized bed reactor can have a H₂/C₂ from a lower limit of 0.00001, 0.00005, or 0.00008 to an upper limit of 0.90000, 0.500000, 0.10000, 0.01500, 0.00700, or 0.00500. One or more embodiments provide that hydrogen is not utilized.

The comonomer distribution, or short chain branching distribution, in an ethylene/α-olefin copolymer can be characterized as either normal (also referred to as having a Zeigler-Natta distribution), reverse (also referred to as having a Broad Orthogonal Composition Distribution (BOCD), or flat. Several reported methods are utilized to quantify a BOCD. Herein, a simple line fit is utilized such that the normal or reverse nature of the comonomer distribution can be quantified by the molecular weight comonomer distribution index (MWCDI), which is the slope of the linear regression of the comonomer distribution taken from a compositional GPC measurement, where the x-axis is Log(MW) and the y-axis is weight percent of comonomer. Short chain branching (SCB) was excluded from the MWCDI calculation according to the formula 0.1>(SCBF)*(MW detector response) where SCBF is the SCB frequency measured in SCB/1000C. A reverse comonomer distribution is defined when the MWCDI>0 and a normal comonomer distribution is defined when the MWCDI<0. When the MWCDI=0 the comonomer distribution is said to be flat. Additionally, the MWCDI quantifies the magnitude of the comonomer distribution. Comparing two polymers that have MWCDI>0, the polymer with the greater MWCDI value is defined to have a greater, i.e., increased, BOCD; in other words, the polymer with the greater MWCDI value has a greater reverse comonomer distribution. Polymers with a relatively greater MWCDI, i.e., BOCD, can provide one or more improved physical properties, as compared to polymers having a relatively lesser MWCDI.

The polymers made with the compositions disclosed herein are unimodal, e.g., in contrast to bimodal. As used herein, “unimodal” refers to polymers that can be characterized by having one peak (one maxima) in a GPC chromatogram showing the molecular weight distribution. Furthermore, a unimodal composition is a composition that is made by utilizing a single catalyst, e.g., a single polyethylene catalyst, in a single reactor. This distinguishes the unimodal composition, as defined above, from bimodal compositions that may appear to have one peak in the GPC chromatogram showing the molecular weight distribution. These bimodal compositions are those that are made by one or more polyethylene catalysts in a staged reactor process, typically a dual reactor process including but not limited to two solution polyethylene reactors, or two gas phase polymer reactors, or two slurry phase polymerization reactors, or combinations thereof such as a sequential slurry and gas phase reactors, such that two different polymers of different densities, and optionally molecular weights are made in the different reactors. Additionally, two or more PE catalysts in a single solution, slurry, or gas phase reactor may produce such a bimodal polymer as described above that appears to have a single peak in a GPC chromatogram showing the molecular weight distribution. This would also be defined as a bimodal polymer composition.

The HDPE resins made with the compositions disclosed herein can have a MWCDI of greater than 0.2 (>0.2). For example, HDPE resins made with the compositions disclosed herein can have a MWCDI from greater than 0.2 to 5. All individual values and subranges from 0.2 to 5 are included; for example, the HDPE resin can have a MWCDI from a lower limit of 0.2, 0.5, or 1 to an upper limit of 5, 4, 3.5, or 3.

The HDPE resins made with the compositions disclosed herein can have a polydisperse-composition index (PCI) of greater than 5 (>5). For example, HDPE resins made with the compositions disclosed herein can have a PCI from greater than 5 to 40. All individual values and subranges from 5 to 40 are included; for example, the HDPE resin can have a PCI from a lower limit of 5, 7, or 10 to an upper limit of 40, 30, 25, or 20. The PCI provides a metric to weight the MWCDI of the HDPE resin by the Mw/Mn to better differentiate between unimodal and bimodal samples, as provided in the Examples section herein, and is calculated according to the equation: PCI=[MWCDI /(Mw/Mn)]×100.

The HDPE resins made with the compositions disclosed herein can have a density from 0.950 to 0.960 g/cm³. All individual values and subranges from 0.950 to 0.960 g/cm³ are included; for example, the HDPE resin can have a density from a lower limit of 0.950, 0.951, or 0.952 g/cm³ to an upper limit of 0.960 or 0.958 g/cm³. Density can be determined by according to ASTM D792.

The HDPE resins made with the compositions disclosed herein can have an ESCR F₅₀ from 20 to 50 hours. All individual values and subranges from 20 to 50 hours are included; for example, the HDPE resin can have an ESCR F₅₀ from a lower limit of 20, 22, or 30 hours to an upper limit of 50, 45, or 40 hours. ESCR F₅₀ can be determined according to ASTM D-1693, Condition B, in 10% by volume aqueous Igepal CO-630 solution.

The HDPE resins made with the compositions disclosed herein can have a tensile secant modulus at 2% from 110 ksi to 140 ksi. All individual values and subranges from 110 ksi to 140 ksi are included; for example, the HDPE resin can have a tensile secant modulus at 2% from a lower limit of 110, 115, or 120 ksi to an upper limit of 140, 130, or 125 ksi. Tensile Secant Modulus at 2% can be determined according to ASTM D638.

The HDPE resins made with the compositions disclosed herein can have a melt index (I₂) from 1.000 to 5.000 dg/min. I₂ can be determined according to ASTM D1238 (190° C., 2.16 kg). All individual values and subranges from 1.000 to 5.000 dg/min are included; for example, the HDPE resin can have an I₂ from a lower limit of 1.000, 1.200, 1.400 or 1.6000 dg/min to an upper limit of 5.000, 4.000, 3.500 or 3.000 dg/min.

The HDPE resins made with the compositions disclosed herein can have a melt index (I₂₁) from 10 to 100 dg/min. I₂₁ can be determined according to ASTM D1238 (190° C., 21.6 kg). All individual values and subranges from 10 to 100 dg/min are included; for example, the HDPE resin can have an I₂₁ from a lower limit of 10, 15, 20, 25 or 30 dg/min to an upper limit of 100, 90, 80, 70 or 60 dg/min.

The HDPE resins made with the compositions disclosed herein can have a melt index (I₁₀) from 5 to 40 dg/min. I₁₀ can be determined according to ASTM D1238 (190° C., 10 kg). All individual values and subranges from 5 to 40 dg/min are included; for example, the HDPE resin can have an I₁₀ from a lower limit of 5, 6, 7, 8 or 9 dg/min to an upper limit of 40, 35, 30 or 25 dg/min.

The HDPE resins made with the catalyst compositions disclosed herein can have a weight average molecular weight (Mw) from 80000 to 125000 g/mol. All individual values and subranges from 80000 to 125000 g/mol are included; for example, the HDPE resins can have an Mw from a lower limit of 80000, 90000, 92500, 93500, or 95000 g/mol to an upper limit of 125000, 120000, 110000, or 100000 g/mol. Mw can be determined by gel permeation chromatography (GPC), as is known in the art. GPC is discussed herein.

The HDPE resins made with the compositions disclosed herein can have a number average molecular weight (Mn) from of 25000 to 45000 g/mol. All individual values and subranges from of 25000 to 45000 g/mol are included; for example, the HDPE resins can have an Mn from a lower limit of 25000, 27000, 28000, 29000 or 30000 g/mol to an upper limit of 45000, 42000, 40000, 38000 or 35000 g/mol. Mn can be determined by GPC as discussed herein.

The HDPE resins made with the compositions disclosed herein can have a Z-average molecular weight (Mz) from 180000 to 350000 g/mol. All individual values and subranges from 180000 to 350000 g/mol are included; for example, the HDPE resins can have an Mz from a lower limit of 180000, 190000 or 200000 g/mol to an upper limit of 350000, 300000, or 250000 g/mol. Mz can be determined by GPC.

The HDPE resins made with the compositions disclosed herein can have a molecular weight of the highest peak (Mp) from 60000 to 90000 g/mol. All individual values and subranges from 60000 to 90000 g/mol are included; for example, the HDPE resins can have an Mp from a lower limit of 60000, 65000 or 70000 g/mol to an upper limit of 90000, 85000, or 80000 g/mol. Mp can be determined by GPC.

The HDPE resins made with the compositions disclosed herein can have a weight average molecular weight to number average molecular weight ratio (Mw/Mn) from 2.5 to 3.5. All individual values and subranges from 2.5 to 3.5 are included; for example, the HDPE resins can have an Mw/Mn from a lower limit of 2.5, 2.55, or 2.6 to an upper limit of 3.5, 3.25, or 3.0. Mw/Mn may also be referred to as molecular weight distribution or “MWD”.

The HDPE resins made with the compositions disclosed herein can have an average tensile yield stress (2 in/min) of 3.8 ksi to 4.2 ksi. All individual values and subranges from 3.8 ksi to 4.2 ksi are included; for example, the HDPE resins can have an average tensile yield stress from a lower limit of 3.800, 3.850, or 3.900 ksi to an upper limit of 4.2, 4.1, or 4.0 ksi. Average tensile yield stress was determined using ASTM D638.

The HDPE resins made with the compositions disclosed herein can have a peak melting point (Tm) of greater than 132° C. For example, the HDPE resins made with the compositions disclosed herein can have a peak melting point (Tm) of greater than 132° C. to 135° C. The peak melting point can be determined as discussed herein.

The HDPE resins made with the compositions disclosed herein can have a tensile yield strain (2 in/min) of 9% to 11%. All individual values and subranges from 9% to 11% are included; for example, the HDPE resins can have a tensile yield strain from 9 to 10% or 10 to 11%. Tensile yield strain was determined using ASTM D638.

The HDPE resins made with the compositions disclosed herein can have an average flex modulus (0.05 in/min) of 150 to 200 ksi. All individual values and subranges from 150 to 200 psi are included; for example, the HDPE resins can have an average flex modulus (0.05 in/min) from a lower limit of 150, 160, or 170 to an upper limit of 200, 190, or 180. In one embodiment, the HDPE resins made with the compositions disclosed herein can have an average flex modulus (0.05 in/min) of 170 to 180 ksi. The average flex modulus (0.05 in/min) is measured according to ASTM D790.

The HDPE resins made with the compositions disclosed herein can have an average flex modulus (0.5 in/min) of 190 to 230 ksi. All individual values and subranges from 190 to 230 psi are included; for example, the HDPE resins can have an average flex modulus (0.5 in/min) from a lower limit of 190, 200, or 210 to an upper limit of 230, 225, or 220. The average flex modulus (0.5 in/min) is measured according to ASTM D790.

The HDPE resins made with the compositions disclosed herein can have a flexural secant modulus at 2% (0.05 in/min) from 100 to 140 kilopound per square inch (ksi). All individual values and subranges from 100 to 140 ksi are included; for example, the HDPE resin can have a flexural secant modulus at 2% from a lower limit of 100, 105, or 110 ksi to an upper limit of 140,130, or 120 ksi. Flexural Secant Modulus at 2% can be determined according to ASTM D790 (0.05 in/min).

The HDPE resins made with the compositions disclosed herein can have a flexural secant modulus at 2% (0.5 in/min) from 120 to 170 kilopound per square inch (ksi). All individual values and subranges from 120 to 170 ksi are included; for example, the HDPE resin can have a flexural secant modulus at 2% from a lower limit of 120, 130, or 140 ksi to an upper limit of 170,165, or 160 ksi. Flexural Secant Modulus at 2% can be determined according to ASTM D790 (0.5 in/min).

The HDPE resins made with the compositions disclosed herein can have a Charpy impact (−40° C.) of greater than 5 to 15 kJ/m². All individual values and subranges from 5 to 15 kJ/m² are included; for example, the HDPE resins can have a Charpy impact (−40° C.) from a lower limit of 5, 6, or 7 to an upper limit of 15, 14, or 12 kJ/m². The Charpy impact strength is tested in accordance with ISO 179.

The HDPE resins made with the compositions disclosed herein can advantageously be used for an injection molding or compression molding process to form the closure device, such as a screw cap among others discussed herein. The injection molding or compression molding process can include feeding the HDPE resin into a heated barrel with a rotating screw that facilitates the melting and homogenization of the HDPE resin, after which the molten HDPE resin (110° C. to 400° C.) is injected under high pressure into a mold cavity in the shape of the desired closure device. After the mold cavity is filled, the HDPE resin in the shape of the closure device is allowed to cool before the mold is opened to release the closure device. The resulting closure device can then, as needed, undergo post-processing operations, such as trimming excess material or removing any sprues, runners, or flash. Additional processes like surface finishing, painting, or assembly may be performed depending on the specific requirements of the closure device.

A number of aspects of the present disclosure are provided as follows. Aspect 1 provides a method of forming a closure device, comprising: supplying a high density polyethylene (HDPE) resin having: a density of 0.950 to 0.960 g/cm³; a melt index (I₂) of 1.000 to 5.000 dg/min measured according to ASTM D1238 (190° C., 2.16 kg); a Mn of 25000 to 45000; a Mw of 80000 to 125000; a Mz of 180000 to 350000; and a molecular weight distribution Mw/Mn of 2.5 to 3.5; a molecular weight comonomer distribution index (MWCDI)>0.2 and forming the closure device with the HDPE resin. Aspect 2 provides that for Aspect 1 the HDPE resin has a Charpy impact (−40° C.) of greater than 5 to 15 kJ/m². Aspect 3 provides that for any one of Aspects 1-2 the HDPE has a peak melt temperature (Tm) of greater than 132° C. Aspect 4 provides that for any one of Aspects 1-3 the HDPE has an average tensile yield stress (2 in/min test speed) of 3.8 ksi to 4.2 ksi. Aspect 5 provides that for any one of Aspects 1-4 the HDPE resin has an environmental stress cracking resistance (ESCR) Condition B (F50, 10%) of 20 hours to 50 hours. Aspect 6 provides any one of Aspects 1-5 where the HDPE resin has a tensile secant modulus at 2% from 110 ksi to 140 ksi. Aspect 7 provides any one of Aspects 1-6 where the HDPE resin has a tensile yield strain (2 in/min) of 9% to 11%. Aspect 8 provides any one of Aspects 1-7 where the HDPE resin has an average flex modulus (0.05 in/min) of 150 to 200 ksi. Aspect 9 provides any one of Aspects 1-7 where the HDPE resin has an average flex modulus (0.5 in/min) of 190 to 230 ksi. Aspect 10 provides any one of claims 1-7, wherein the HDPE resin has a flexural secant modulus at 2% (0.05 in/min) from 100 to 140 ksi. Aspect 11 provides any one of claims 1-7, wherein the HDPE resin has a flexural secant modulus at 2% (0.5 in/min) from 120 to 170 ksi. Aspect 12 provides any one of Aspects 1-11 where the HDPE resin has a melt index (I₁₀) of 5 to 40 dg/min determined according to ASTM D1238 (190° C., 10 kg). Aspect 13 provides any one of Aspects 1-10 where the HPDE resin has a polydisperse-composition index (PCI)>5. Aspect 14 provides any one of Aspects 1-13 where forming the closure device includes compression molding or injection molding the HDPE resin to form the closure device. Aspect 15 provides a method for making the HDPE resin of any one of aspects 1-14, the method comprising: making a catalyst composition utilizing an asymmetrical hafnium metallocene; and contacting the catalyst composition and ethylene and, optionally, a comonomer selected from the group consisting of propene and a (C4-C20)alpha-olefins to make the HDPE resin. Aspect 16 provides a method for making the HDPE resin of any one of aspects 1-14, the aspect comprising: making a catalyst composition utilizing an asymmetrical hafnium metallocene having an n-propyl cyclopentadienyl ligand represented by structure (I):

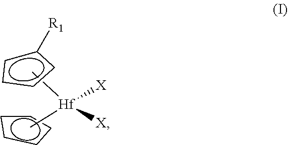

where R¹ n-propyl; and each X is independently a leaving group; and contacting the catalyst composition and ethylene and, optionally, a comonomer selected from the group consisting of propene and a (C4-C20)alpha-olefins to make the HDPE resin. Aspect 17 provides a closure device formed by any one of Aspects 1-16. Aspect 18 provides that for Aspect 17, the closure device is a screw cap.

### EXAMPLES

### Synthesis of (n-Propylcylopentadienyl)hafnium(IV) trichloride, Dimethoxyethane Adduct (Adduct)

(n-Propylcylopentadienyl)hafnium(IV) trichloride, dimethoxyethane adduct (Adduct), is represented by the following:

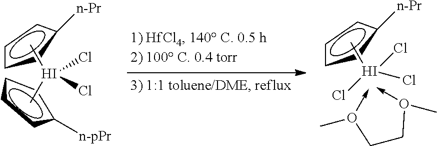

and was synthesized by adapting the procedure described in WO2016/168448A1 by Harlan. Bis(n-propylcyclopentadienyl)hafnium dichloride (25.1 g, 54.1 mmol) was heated to 140° C. in a 100 mL round-bottom flask until melted. HfCl₄ (17.5 g, 54.6 mmol) was added to the flask as a solid powder. The contents were heated at 140° C. for approximately 30 minutes and formed a brown viscous liquid. The 100 mL round bottom flask was attached to a short path distillation apparatus which consisted of a glass tube (90° bend) that was attached to a Schlenk flask. A vacuum was pulled on the assembly through the stopcock of the Schlenk flask. Distillation was performed from 105° C. to 110° C. with 0.4 torr vacuum. Over about an hour most of the material distilled/sublimed into the Schlenk flask or remained in the glass tube. The solid material in the u-tube was scraped out and combined with the material in the Schlenk flask. To this solid was added toluene (50 mL) and dimethoxyethane (50 mL). This was heated to reflux forming a solution, additional toluene (50 mL) was added. Upon cooling colorless needles formed. Pentane (200 mL) was added causing further formation of solid precipitate. The solid was isolated by filtration, washed with pentane (2×50 mL) and dried under vacuum to provide the Adduct (42.2 g); cooling the combined supernatant and washings resulted an additional 2.6 g of Adduct that was isolated. Total yield=44.8 g (86%).

### Synthesis of (n-Propylcyclopentadineyl)(Cyclopentadienyl)hafnium(IV) Dichloride

(n-Propylcyclopentadineyl)(Cyclopentadienyl)hafnium(IV)dichloride ((n-PrCp)(Cp)HfCl₂):

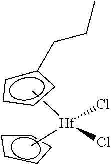

was prepared as follows. In a glove box, 0.75 g (1.56 mmol) of the (n-propylcylopentadienyl)hafnium(IV) trichloride, dimethoxyethane adduct (grey solid) was added to an oven-dried 4 oz. glass jar. A teflon-coated stir bar and 40 mL of dry toluene was added to the Adduct and the contents of the jar stirred via magnetic stirring to form a slurry. The slurry was grey and cloudy. One (1) molar equivalent of cyclopentadienyllithium (CpLi) (white solid) was then slowly added to the slurry and then allowed to stir overnight at room temperature (20° C.). NMR spectra indicated formation of desired product with some unreacted starting material. The mixture was allowed to stir at room temperature for an additional 5 days. The entire reaction mixture was filtered and the volatiles removed from filtrate under reduced pressure. The solids were recrystallized from warm hexanes and toluene. 0.419 g light grey solids were isolated (63.9% total yield after recrystallization). ¹H and ¹³C NMR spectra confirmed desired product. ¹H NMR (400 MHz, Benzene-de) δ 5.86 (s, 3H), 5.77-5.72 (m, 2H), 5.57 (t, J=2.7 Hz, 2H), 2.63-2.54 (m, 2H), 1.48-1.35 (m, 2H), 0.80 (t, J=7.3 Hz, 3H). ¹³C NMR (101 MHz, Benzene-d₆) δ 132.81, 115.78, 114.13, 110.86, 32.38, 24.34, 14.00.

### Preparation of Spray Dried Hafnocene Catalyst (IE 1)

Preparation of spray-dried hafnocene catalyst (IE 1) was as follows. The spray-dried hafnocene catalyst was made from (n-propylcyclopentadineyl)(cyclopentadienyl)hafnium(IV) dichloride and a support material. In a 13-gallon mix tank mix 2.38 lbs of hydrophobic fumed silica (CABOSIL® TS-610) and 37.0 lbs 10 wt. % methylaluminoxane (MAO) in toluene. To the mixture add 80.0 g of (propylcyclopentadineyl)(cyclopentadienyl)hafnium(IV) dichloride along with an additional 20 lbs of toluene were added to the contents of the container while mixing. Then, the contents of the container were spray-dried (146° C. inlet temperature; 84° C. outlet temperature; 14 lbs/hr slurry inlet feed, 20000 rpm atomizer speed) to provide 4.1 pounds of the spray-dried hafnocene catalyst (IE 1) as a powder.

Polymerizations were performed as follows. The polymerization utilized a pilot scale fluidized bed gas phase polymerization reactor that included a reactor vessel containing a fluidized bed of a powder of ethylene/alpha-olefin copolymer, and a distributor plate disposed above a bottom head, and defining a bottom gas inlet, and having an expanded section, or cyclone system, at the top of the reactor vessel to decrease resin fines that may escape from the fluidized bed. The expanded section defined a gas outlet. The reactor further included a compressor blower that was utilized to continuously cycle gas around from out of the gas outlet in the expanded section in the top of the reactor vessel through a cycle loop down to and into the bottom gas inlet of the reactor and through the distributor plate and fluidized bed. The reactor further included a cooling system that removed heat of polymerization and maintained the fluidized bed at a target temperature. Compositions of gases such as ethylene, alpha-olefin, and hydrogen were fed into the reactor and monitored by an in-line gas chromatograph in the cycle loop to maintain specific concentrations that were used to control polymer properties. The spray-dried catalyst was fed as a slurry or dry powder into the reactor from high pressure devices, where the slurry was fed via a syringe pump and the dry powder was fed via a metered disk. The catalyst entered the fluidized bed in the lower ⅓ of the bed height. The polymerization system weighed the fluidized bed and included isolation ports that discharged the polymerization product from the reactor vessel in response to an increase of the fluidized bed weight as the polymerization reaction proceeded. Polymerization conditions for Inventive Example 2 (IE 2) are reported in Table 1.

TABLE 1
Continuous Polymerization Reactor Process
Data for Inventive Example 2 (IE 2)

| Sample | IE 2 |
|---|---|
| Catalyst | IE 1 |
| Avg. Reactor Temp [° C.] | 80.00 |
| Avg. H2/C2 Molar Ratio | 0.000644 |
| Avg. H2/PPM/C2% Ratio | 6.438 |
| Avg. H2/C2 Flow Ratio (lb/hr) | 0.056 |
| Avg. C2PP [psi] | 130.3 |
| Avg. C2 Flow (lb/hr) | 64.964 |
| Avg. C6/C2 (molar Ratio) | 0.0002 |
| Avg. C6/C2 Flow Ratio | 0.0008 |
| Reactor Pressure (psi) | 350 |
| Slurry Cat Feed Rate (cc/hr) | 11 |
| Trim Solution Feed (lb/hr) | 0.0 |
| Avg. Residence Time | 2.67 |
| Avg. Bed Weight [lb] | 126.7261 |
| Productivity (lb/lb) | 10192 |

Six commercially obtained polymers were utilized as comparative examples: Comparative Example 1 (CE 1), unimodal polymer DOW™ HDPE XDMDA-1227 made with UCAT-J catalyst, density of 0.952 g/cm3, melt index (I₂) of 2.7 dg/min; Comparative Example 2 (CE 2), unimodal polymer obtained from UNIVATION TECHNOLOGIES, made with VP-100 catalyst, density of 0.952 g/cm3, melt index (I₂) of 3.72 dg/min. Comparative Example 3 (CE 3), bimodal polymer CONTINUUM™ DMDC-1270 made with UCAT-J catalyst, density of 0.955 g/cm3, melt index (I₂) of 2.5 dg/min; Comparative Example 4 (CE 4), bimodal polymer CONTINUUM™ DMDC-1250 made with UCAT-J catalyst, density of 0.955 g/cm3, melt index (I₂) of 1.5 dg/min. Comparative Example 5 (CE 5), unimodal polymer DOW™ DMDA-8904 made with UCAT-J catalyst, density of 0.952 g/cm3, melt index (I₂) of 4.4 dg/min. Comparative Example 6 (CE 6), unimodal polymer DOW™ DMDA-8907 made with UCAT-J catalyst, density of 0.952 g/cm3, melt index (I₂) of 6.8 dg/min.

Additional commercially obtained polymers were used to investigate the relationship between density and peak melting temperatures: DOW™ HDPE KT 10000 (density of 0.964 g/cm³, melt index (I₂) of 8 dg/min), EVERCAP™ DMDB 1220 (density of 0.958 g/cm³, melt index (I₂) of 0.3 dg/min), EVERCAP™ DMDA 1260 (density of 0.963 g/cm³, melt index (I₂) of 2.7 dg/min), DOW™ DMDC 1210 (density of 0.952 g/cm³, melt index (I₂) of 10 dg/min), DOW™ DMDA 8920 (density of 0.954 g/cm³, melt index (I₂) of 20 dg/min)., DOW™ DMDA 8933 (density of 0.950 g/cm³, melt index (I₂) of 33 dg/min), DOW™ DMDA-8007 (density of 0.965 g/cm³, melt index (I₂) of 8.3 dg/min), and DOW™ DMDA 8940 (density of 0.951 g/cm³, melt index (I₂) of 44 dg/min).

A number of properties were determined for the polymers. The results are reported in Tables 2-3. Melt index (I₂) was determined according to ASTM D1238 (190° C., 2.16 kg), melt index (I₁₀) was determined according to ASTM D1238 (190° C., 10 kg), melt index (I₂₁) was determined according to ASTM D1238 (190° C., 21.6 kg); density was determined according to ASTM D792. Mn, Mw, Mz, Mp, and Mw/Mn were determined by GPC as discussed herein; Environmental Stress Cracking Resistance (ESCR) F₅₀ was determined according to ASTM D-1693, Condition B, in 10% by volume aqueous Igepal CO-630 solution. Charpy impact strength is performed in accordance with ISO 179; Tensile properties (tensile yield strain, tensile yield stress, tensile secant modulus at 2%) were determined according to ASTM D638 (test speed 2 in/min). Flexural properties (flexural modulus and flexural secant modulus at 2%) were determined according to ASTM D790 (test speeds at 0.5 in/min and 0.05 in/min). Crystallization enthalpy, peak crystallization temperature, melting enthalpy, and peak melting temperature are determined via Differential Scanning Calorimetry as discussed herein.

### Compositional Conventional GPC

The chromatographic system consisted of a PolymerChar GPC-IR (Valencia, Spain) high temperature GPC chromatograph equipped with an internal IR5 infra-red detector (IR5). The autosampler oven compartment was set at 160° C. and the column compartment was set at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000, and 0.05 grams in 50 milliliters of solvent for molecular weights less than 1,000,000. The polystyrene standards were pre-dissolved at 80° C. with gentle agitation for 30 minutes then cooled and the room temperature solution is transferred cooled into the autosampler dissolution oven at 160° C. for 30 minutes. The polystyrene standard peak molecular weights were converted to polyethylene molecular weights using Equation 1 (as described in Williams and Ward, J. Polym. Sci., Polym. Let., 6, 621 (1968)).:

$${M}_{polyethylene} = A \times {( {M}_{polystyrene} )}^{B} \qquad ( EQ 1 )$$

where M is the molecular weight, A has a value of 0.4070 and B is equal to 1.0.

A fifth order polynomial was used to fit the respective polyethylene-equivalent calibration points.

The total plate count of the GPC column set was performed with decane which was introduced into blank sample via a micropump controlled with the PolymerChar GPC-IR system. The plate count for the chromatographic system should be greater than 18,000 for the 4 Agilent “Mixed A” 30 cm 20-micron linear mixed-bed columns.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° C. under “low speed” shaking.

The calculations of Mn_{(GPC)}, Mw_{(GPC)}, and Mz_{(GPC)} were based on GPC results using the internal IR5 detector (measurement channel) of the PolymerChar GPC-IR chromatograph according to Equations 2-4, using PolymerChar GPCOne™ software, the baseline-subtracted IR chromatogram at each equally-spaced data collection point (i), and the polyethylene equivalent molecular weight obtained from the narrow standard calibration curve for the point (i) from Equation 1.

$${Mn}_{( GPC )} = \frac{{\sum }^{i} I {R}_{i}}{{\sum }^{i} ( I {R}_{i} / {M}_{{polyethylene}_{i}} )} \qquad ( EQ 2 )$$

$${Mw}_{( GPC )} = \frac{{\sum }^{i} ( I {R}_{i} * {M}_{{polyethylene}_{i}} )}{{\sum }^{i} I {R}_{i}} \qquad ( EQ 3 )$$

$${Mz}_{( GPC )} = \frac{{\sum }^{i} ( I {R}_{i} * {M}_{{polyethylene}_{i}}^{2} )}{{\sum }^{i} ( I {R}_{i} * {M}_{{polyethylene}_{i}} )} \qquad ( EQ 4 )$$

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. After calibrating the system based on a flow marker peak, the effective flowrate (with respect to the narrow standards calibration) is calculated as Equation 5. Processing of the flow marker peak was done via the PolymerChar GPCOne™ Software. Acceptable flowrate correction is such that the effective flowrate should be within +/−0.5% of the nominal flowrate.

Flowrate(effective)=Flowrate(nominal)*(RV(FM Calibrated)/RV(FM Sample)) (EQ5)

### IR5 GPC Octene Composition Calibration

A calibration for the IR5 detector rationing was performed using at least ten ethylene-based polymer standards (Octene as comonomer) made by single-site metallocene catalyst from a single reactor in solution process (polyethylene homopolymer and ethylene/octene copolymers) of a narrow SCB distribution and known comonomer content (as measured by ¹³C NMR Method, Qiu et al., Anal. Chem. 2009, 81, 8585-8589), ranging from homopolymer (0 SCB/1000 total C) to approximately 40 SCB/1000 total C, where total C=carbons in backbone+carbons in branches. Each standard had a weight-average molecular weight from 36,000 g/mole to 126,000 g/mole measured by GPC. Each standard had a molecular weight distribution (Mw/Mn) from 2.0 to 2.5. Polymer properties for the SCB standards are shown in Table A.

TABLE A
“Copolymer” Standards

| Wt % | | | | |
|---|---|---|---|---|
| Comonomer | IR5 Area ratio | SCB/1000 Total C | Mw | Mw/Mn |
| 23.1 | 0.2411 | 28.9 | 37,300 | 2.22 |
| 14.0 | 0.2152 | 17.5 | 36,000 | 2.19 |
| 0.0 | 0.1809 | 0.0 | 38,400 | 2.20 |
| 35.9 | 0.2708 | 44.9 | 42,200 | 2.18 |
| 5.4 | 0.1959 | 6.8 | 37,400 | 2.16 |
| 8.6 | 0.2043 | 10.8 | 36,800 | 2.20 |
| 39.2 | 0.2770 | 49.0 | 125,600 | 2.22 |
| 1.1 | 0.1810 | 1.4 | 107,000 | 2.09 |
| 14.3 | 0.2161 | 17.9 | 103,600 | 2.20 |
| 9.4 | 0.2031 | 11.8 | 103,200 | 2.26 |

The “IR5 Area Ratio (or “IR5_{Methyl Channel Area}/IR5_{Measurement Channel Area}”)” of “the baseline-subtracted area response of the IR5 methyl channel sensor” to “the baseline-subtracted area response of IR5 measurement channel sensor” (standard filters and filter wheel as supplied by PolymerChar: Part Number IR5_FWM01 included as part of the GPC-IR instrument) was calculated for each of the “Copolymer” standards. A linear fit of the Wt % Comonomer frequency versus the “IR5 Area Ratio” was constructed in the form of the following Equation 6:

$$Wt \% Comonomer = {A}_{0} + [ {A}_{1} \times ( I R {5}_{Methyl Channel Area} / I R {5}_{Measurement Channel Area} ) ] \qquad ( EQ 6 )$$

where A₀ is the “Wt % Comonomer” intercept at an “IR5 Area Ratio” of zero, and A₁ is the slope of the “Wt % Comonomer” versus “IR5 Area Ratio” and represents the increase in the Wt % Comonomer as a function of “IR5 Area Ratio.” The IR5 area ratio is equal to the IR5 height ratio for narrow PDI and narrow SCBD standard materials.

Differential Scanning Calorimetry (DSC) can be used to measure the crystallinity of a sample at a given temperature for a wide range of temperatures. For example, a TA Instruments (Discovery), equipped with a RCS (Refrigerated Cooling System) and an autosampler module is used to perform this analysis. During testing, a nitrogen purge gas flow of 50 ml/min is used. Each sample is pressed into a thin film and melted in the press at about 190° C.; the melted sample is then air-cooled to room temperature (approximately 25° C.). A 3-10 mg, 6 mm diameter specimen is extracted from the cooled polymer, weighed, placed in a light aluminum pan (ca 50 mg), and crimped shut. Analysis is then performed to determine its thermal properties. The thermal behavior of the sample is determined by ramping the sample temperature up and down to create a heat flow versus temperature profile. First, the sample is rapidly heated to 180° C. and held isothermal for 5 minutes in order to remove its thermal history. Next, the sample is cooled to −40° C. at a 10° C./minute cooling rate and held isothermal at −40° C. for 5 minutes. The sample is then heated to 150° C. (this is the “second heat” ramp) at a 10° C./minute heating rate. The cooling and second heating curves are recorded. The cool curve is analyzed by setting baseline endpoints from the beginning of crystallization to −20° C. The heat curve is analyzed by setting baseline endpoints from −20° C. to the end of melt. The peak crystallization temperature (Tc), the heat of fusion (Hc) (also known as Crystallization Enthalpy) were determined from the 1st cool curve. The heat of fusion (Hm) (also known as melt enthalpy) and the peak melting temperature (Tm) were determined from the 2nd heat curve.

Flexural Testing were conducted according to ASTM D790. The polymer pellet samples are compression molded at 190° C. to a nominal thickness of 0.125 inch according to ASTM D4703 per Appendix A.1 Procedure C. Samples are conditioned at 23 (±2) ° C. and 50 (±10) % R.H. for at least 40 hours. Sample geometry (length, depth, thickness) is 5″×0.5″×0.125″. Samples are tested flatwise with a span of 2″ for ASTM. Test speed is such that the flexural-strain rate is 1%/min, translating to 0.05 in/min. Additionally testing allows for a strain rate of 10%/min. From the resulting stress-strain data, Flexural modulus is reported from the initial slope of the curve. Secant modulus at 1% and 2% are reported as the slope of the line from the origin to a 1% and 2% strain, respectively.

Tensile Testing were conducted according to ASTM D638. The pellet samples are compression molded at 190° C. to a nominal thickness of 0.075 inch (Type IV geometry) according to ASTM D4703 per Appendix A.1 Procedure C. Type IV samples are die cut from the sheet and conditioned at 23 (±2) ° C. and 50 (±10) % R.H. for at least 40 hours. The Type IV samples are tested in tension according to D638 (Standard Test Method for Tensile Properties of Plastics) and D4976 (Standard Specification for Polyethylene Plastics Molding and Extrusion Materials). Test speed is 2″/in or 20″/min crosshead displacement. The strain is measured using an extensometer attached to the sample at an initial gauge length of 1 inch. Modulus measurements are made using the slope of the initial portion of the stress-strain curve.

Environmental Stress Cracking Resistance (ESCR) Testing is performed according to ASTM D1693. The pellet samples were compression molded at 190° C. to the required nominal thickness (0.0755″ for Condition B) according to ASTM D4703 per Annex A.1 Procedure C. The samples are tested according to ASTM D1693. The compression molded sheet is conditioned at 23° C. (+/−2° C.) and 50% RH (+/−10% RH) and the individual coupons are stamped out using an appropriate die within 24 hours of molding. The sample thickness is measured to ensure they are within the ASTM specifications for the appropriate Condition B. The coupons are further conditioned at 23° C. (+/−2° C.) and 50% RH (+/−5% RH) and tested at least 40 hours after compression molding and within 96 hours of compression molding. Immediately prior to testing, the samples are notched to the required depth and then bent and loaded into the specimen holder. The holder is then placed in a test tube and the tube filled with the appropriate strength Igepal solution (10%). The tube is sealed and placed in a controlled temperature water bath at 50° C. The samples are observed twice daily for cracks during the first week of testing, after which they are observed daily. F50 is calculated based on the graphical method, but automated within a spreadsheet.

Charpy testing is performed following ISO 179. Samples are fabricated from compression molded sheets. For compression molding, the pellet samples were molded at 190° C. to a nominal thickness of 4 mm. The pellets were weighed and placed in an appropriate picture frame chase. The chase has Mylar release sheets on each side and with copper or brass plates backing. The sample is placed in a hot press under low, contact pressure (3,000 psi) for 4 minutes and then placed under high pressure (30,000 psi) for a further 6 minutes. After this, the sample is controlled cooled at 15° C./min (+/−2° C./min) until the sample is at approximately 35° C. at which point it is removed from the press. Specimens are cut from the sheet with an appropriate die to give samples 80 mm in length and 10 mm in width. The samples are notched on the long side in the thickness direction using an automated notcher to leave a ligament width of 8 mm. The notching half angle is 22.5° and the radius of curvature at the tip is 0.25 mm. The samples are conditioned for at least 40 hours at 23+/−2° C. and 50+/−10% R.H. For samples that are tested at non-ambient temperatures, the specimens are further conditioned at the test temperature for a minimum of 1 hour. Specimens are loaded into the Charpy Izod tester with the notch directed away the impactor. The pendulum is released and the energy absorbed during the test is automatically recorded. The specimen is examined post-test and the type of failure noted (Complete, hinged, partial or no-break). Ten replicates are tested per sample per temperature.

The resin design of the inventive example provided an outstanding tensile property. As seen in Table 2, IE 2 shows improved tensile yield stress over CE 2, which is of comparable I₂ and density but without the inventive molecular weight distribution. It is worth noting that IE 2, a unimodal resin, even showed better yield stress than CE 3 and CE 4, which are two state-of-the-art bimodal resins.

The resin design of the inventive example provided outstanding ESCR performance when compared with unimodal resins of similar I₂ and density. IE 2 showed better ESCR than CE 1 and CE 2, which can be attributed to the positive Broad Orthogonal Composition Distribution (BOCD), which indicates a relatively larger reverse comonomer distribution value.

The innovate resin design of IE 2 also leads to high Charpy impact strength, which can be seen from the comparison between IE 2 and CE 5. IE 2 and CE 5 share similar Mw (97436 vs. 87829), while IE 2 exhibits nearly double Charpy impact strength measured under 0° C. CE 4 is a bimodal resin with comparable I₂ and density, however, IE 2 shows better Charpy impact strength as a unimodal resin. It is worth noting that it is very challenging for a unimodal resin to outperform a bimodal resin in mechanical properties.

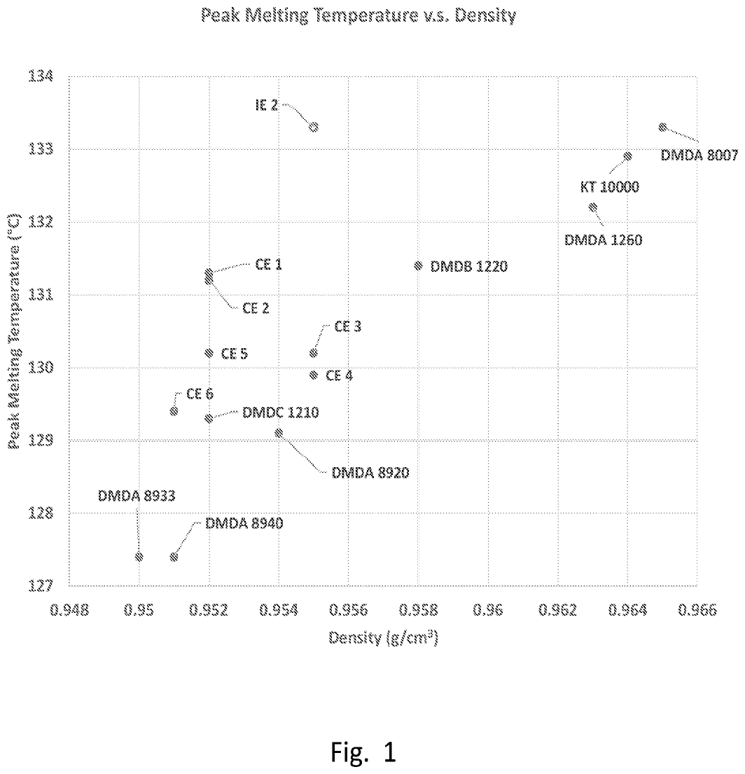

The unique resin architecture disclosed herein also result in unusually high peak melting temperature. Usually, the peak melting temperature of a high density polyethylene is determined by its density (FIG. 1 and Table 3), but IE 2 is an obvious outlier. The peak melting temperature of IE 2 is higher than other resins with similar density (e.g., DMDA 8920, DMDC 1210). The peak melting temperature of IE 2 is even higher than DMDA 1260, which is 0.01 g/cm³ denser than IE 2.

TABLE 2
Polymer Properties

| | IE 2 | CE 1 | CE 2 | CE 3 | CE 4 | CE 5 | CE 6 |
|---|---|---|---|---|---|---|---|
| I2 (dg/min) | 2.18 | 2.70 | 3.72 | 2.50 | 1.50 | 4.40 | 6.80 |
| I10 (dg/min) | 12.58 | | | 26.86 | 19.92 | 34.45 | 45.18 |
| I21 (dg/min) | 36.55 | 67.40 | 64.90 | | | | |
| Density (g/cc) | 0.955 | 0.952 | 0.952 | 0.955 | 0.955 | 0.952 | 0.951 |
| ESCR F50 (hr, | 25 | 20 | 8.5 | 100 | 272 | 22 | 12 |
| Cond B, 10%) | | | | | | | |
| Mn | 33,802 | 25,723 | 30,379 | 13,502 | 9,649 | 21,491 | 19,702 |
| Mw | 97,436 | 99,508 | 80,453 | 110,948 | 122,706 | 87,829 | 79,893 |
| Mz | 226,233 | 386,178 | 171,021 | 602,428 | 710,831 | 372,966 | 328,688 |
| Mp | 75,568 | 54,602 | 56,070 | 36,686 | 20,881 | 50,059 | 47,129 |
| Mw/Mn | 2.88 | 3.87 | 2.65 | 8.22 | 12.72 | 4.09 | 4.06 |
| Mz/Mw | 2.32 | 3.88 | 2.13 | 5.43 | 5.79 | 4.25 | 4.11 |
| MWCDI | 0.35 | −0.16 | −0.21 | 0.09 | 0.13 | −0.80 | −0.66 |
| PCl | 12.15 | −4.13 | −7.92 | 1.09 | 1.02 | −19.56 | −16.26 |
| Tensile Yield | 10.05 | 10.16 | 11.05 | 10.20 | 8.64 | 10.21 | 10.26 |
| Strain (%) | | | | | | | |
| Tensile Yield | 3.992 | 3.708 | 3.984 | 3.640 | 3.902 | 3.636 | 3.732 |
| Stress (ksi) | | | | | | | |
| Tensile Secant | 123.4 | 123.4 | | 120.1 | 134.6 | 119.0 | 123.5 |
| Mod at 2% | | | | | | | |
| (ksi) | | | | | | | |
| Flexural modulus | 178 | 187 | 170 | 188 | 169 | | |
| (ksi, 0.05 in/min) | | | | | | | |
| Flexural Secant | 117 | 120 | 112 | 122 | 115 | | |
| Modulus At 2% | | | | | | | |
| (ksi, 0.05 in/min) | | | | | | | |
| Flexural modulus | 217 | | 215 | 236 | 212 | 200 | 194 |
| (ksi, 0.5 in/min) | | | | | | | |
| Flexural Secant | 150 | | 146 | 159 | 142 | 148 | 143 |
| Modulus At 2% | | | | | | | |
| (ksi, 0.5 in/min) | | | | | | | |
| Crystallization | 218 | 221 | 221.2 | 217.3 | 217.5 | 219.3 | 217.4 |
| Enthalpy (J/g) | | | | | | | |
| Peak | 117.8 | 118.3 | 116.7 | 117.5 | 117.3 | 117.8 | 116.7 |
| Crystallization | | | | | | | |
| Temperature | | | | | | | |
| (° C.) | | | | | | | |
| Melting Enthalpy | 215.5 | 218.7 | 218.7 | 214.4 | 211.9 | 216 | 21 |
| (J/g) | | | | | | | |
| Peak Melting | 133.3 | 131.3 | 131.2 | 130.5 | 129.9 | 130.2 | 129.4 |
| Temperature | | | | | | | |
| (° C.) | | | | | | | |
| 23° C. Charpy | | | | | 10.40 | 13.56 | |
| Impact Strength | | | | | | | |
| (kj/m2) | | | | | | | |
| 0° C. Charpy | 14.01 | | | | | 7.46 | |
| Impact Strength | | | | | | | |
| (kj/m2) | | | | | | | |
| −20° C. Charpy | | | | | 5.54 | 7.333 | |
| Impact Strength | | | | | | | |
| (kj/m2) | | | | | | | |
| −40° C. Charpy | 10.06 | | | | | | |
| Impact Strength | | | | | | | |
| (kj/m2) | | | | | | | |

TABLE 3
Density and peak melting temperature
relationship of incumbent resins

| Example | Density (g/cm³) | Peak Melting Temperature (° C.) |
|---|---|---|
| IE 2 | 0.955 | 133.3 |
| KT 10000 | 0.964 | 132.9 |
| DMDB 1220 | 0.958 | 131.4 |
| CE 4 | 0.955 | 129.9 |
| CE 3 | 0.955 | 130.2 |
| DMDA 1260 | 0.963 | 132.2 |
| DMDC 1210 | 0.952 | 129.3 |
| CE 2 | 0.952 | 131.2 |
| CE 5 | 0.952 | 130.2 |
| CE 6 | 0.951 | 129.4 |
| CE 1 | 0.952 | 131.3 |
| DMDA 8920 | 0.954 | 129.1 |
| DMDA 8933 | 0.950 | 127.4 |
| DMDA 8007 | 0.965 | 133.3 |
| DMDA 8940 | 0.951 | 127.4 |

1. A method of forming a closure device, comprising:
supplying a high density polyethylene (HDPE) resin having:
a density of 0.950 to 0.960 g/cm³;
a melt index (I₂) of 1.000 to 5.000 dg/min measured according to ASTM D1238 (190° C., 2.16 kg);
a Mn of 25000 to 45000;
a Mw of 80000 to 125000;
a Mz of 180000 to 350000; and
a molecular weight distribution Mw/Mn of 2.5 to 3.5;
molecular weight comonomer distribution index (MWCDI)>0.2; and
forming the closure device with the HDPE resin.

2. The method of claim 1, wherein the HDPE resin has a Charpy impact (−40° C.) of greater than 5 to 15 kJ/m².

3. The method of claim 1, wherein the HDPE has a peak melting point (Tm) of greater than 132° C.

4. The method of claim 1, wherein the HDPE has an average tensile yield stress (2 in/min test speed) of 3.8 ksi to 4.2 ksi.

5. The method of claim 1, wherein the HDPE resin has an environmental stress cracking resistance (ESCR) Condition B (F50, 10%) of 20 hours to 50 hours.

6. The method of claim 1, wherein the HDPE resin has a tensile secant modulus at 2% from I₁₀ ksi to 140 ksi.

7. The method of claim 1, wherein the HDPE resin has a tensile yield strain (2 in/min) of 9% to 11%.

8. The method of claim 1, wherein the HDPE resin has an average flex modulus (0.05 in/min) of 150 to 200 ksi.

9. The method of claim 1, wherein the HDPE resin has an average flex modulus (0.5 in/min) of 190 to 230 ksi.

10. The method of claim 1, wherein the HDPE resin has a flexural secant modulus at 2% (0.05 in/min) from 100 to 140 ksi.

11. The method of claim 1, wherein the HDPE resin has a flexural secant modulus at 2% (0.5 in/min) from 120 to 170 ksi.

12. The method of claim 1, wherein the HDPE resin has a melt index (I₁₀) of 5 to 40 dg/min determined according to ASTM D1238 (190° C., 10 kg).

13. The method of claim 1, wherein the HDPE resin has a polydisperse-composition index (PCI)>5.

14. The method of claim 1, wherein forming the closure device includes compression molding or injection molding the HDPE resin to form the closure device.

15. A method for making the HDPE resin of claim 1, the method comprising:
making a catalyst composition utilizing an asymmetrical hafnium metallocene; and contacting the catalyst composition and ethylene and, optionally, a comonomer selected from the group consisting of propene and a (C4-C20)alpha-olefins to make the HDPE resin.

16. A method for making the HDPE resin of claim 1, the method comprising:
making a catalyst composition utilizing an asymmetrical hafnium metallocene having an n-propyl cyclopentadienyl ligand represented by structure (I): 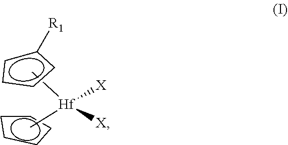
wherein R¹ n-propyl; and each X is independently a leaving group; and
contacting the catalyst composition and ethylene and, optionally, a comonomer selected from the group consisting of propene and a (C4-C20)alpha-olefins to make the HDPE resin.

17. A closure device formed by the method of claim 1.

18. The closure device of claim 17, wherein the closure device is a screw cap.
